(19) United States
(12) Patent Application Publication
(10) Pub. No.: US 2015/0087263 A1
(43) Pub. Date: Mar. 26, 2015

(54) Methods and Apparatus for Promotions and Large Scale Games in Geo-Fenced Venues

(71) Applicant: Bennett Hill Branscomb, Ingleside, TX (US)

(72) Inventor: Bennett Hill Branscomb, Ingleside, TX (US)

(21) Appl. No.: 14/495,691

(22) Filed: Sep. 24, 2014

Related U.S. Application Data
(60) Provisional application No. 61/881,503, filed on Sep. 24, 2013.
(60) Provisional application No. 62/030,252, filed on Jul. 29, 2014.

(51) Int. Cl. H04W 4/02; H04W 64/00; G06Q 30/02; H04W 12/04

(52) U.S. Cl. CPC H04W 4/021; H04W 12/04; H04W 64/00; G06Q 30/0252
USPC 455/410; 455/456.3

(57) ABSTRACT

A method and apparatus for a system's customer to capture a user's contact information or location during an event uses an application for a personal electronic device that senses a jolt registered by the accelerometer of the device, and/or the user's location based on location sensors within the device. In response, the user receives any combination of text, picture(s), sound, or encrypted barcode, specified by the customer. A method for providing geo-referenced, selective control of wireless, processor-based devices (e.g., smartphones) uses an encrypted software master key that is at least initially assigned to the owner-of-record of real property. The master key functions to enable, disable, activate or otherwise control programs on or features of processor-based devices that are determined to be within the geographic boundaries of the real property. In certain embodiments, a system is linked to real property records to assign the master key to the owner of record.

### CROSS-REFERENCE TO RELATED APPLICATIONS

This application claims the benefit of U.S. Provisional Application No. 61/881,503 filed on Sep. 24, 2013, and U.S. Provisional Application No. 62/030,252 filed on Jul. 29, 2014, the disclosures of which are hereby incorporation by reference in their entireties.

### STATEMENT REGARDING FEDERALLY SPONSORED RESEARCH OR DEVELOPMENT

Not Applicable

### BACKGROUND OF THE INVENTION

1. Field of the Invention

The present invention generally relates to mobile electronic devices. More particularly, it relates to the use of mobile electronic devices having location sensors and wireless communications capabilities in advertising and promotions.

2. Description of the Related Art Including Information Disclosed Under 37 CFR 1.97 and 1.98.

A geo-fence is a virtual perimeter for a real-world geographic area. A geo-fence may be dynamically generated—as, for example, a radius around a store or point location. Or a geo-fence may be a predefined set of boundaries, for example, school attendance zones or neighborhood boundaries. Custom-digitized geo-fences have been in use for multiple online mapping applications since at least 2004.

When the location-aware device of a location-based service (LBS) user enters or exits a geo-fence, the device receives a generated notification. This notification may contain information about the location of the device. The geo-fence notice may be sent to a mobile telephone or an email account.

Geo-fencing, used with child location services, may notify parents if a child leaves a designated area. Geo-fencing is a critical element to telematics hardware and software. It allows users of the system to draw zones around places of work, customer's sites and secure areas. These geo-fences, when crossed by an equipped vehicle or person, may trigger a warning to the user or operator via SMS, e-mail or other communication means. Other applications include sending an alert if a vehicle is stolen and notifying rangers when wildlife stray into farmland.

Geo-fencing, in a security strategy model, may provide security to wireless local area networks. This may be done by using predefined borders, e.g., an office space with borders established by positioning technology attached to a specially programmed server. The office space becomes an authorized location for designated users and wireless mobile devices.

The increasing popularity of mobile advertising has led to geo-fencing being used to distribute location-specific ads to potential customers on their mobile electronic devices.

Large scale entertainment events such as concerts offer excellent opportunities for new and creative promotional activities. These opportunities have been substantially broadened by the proliferation of personal electronic devices such as cell phones and tablets due to their constant connectivity, position tracking, and versatility. There is a pressing need to develop systems for incorporating these modern electronic devices into promotional activities during large scale entertainment events.

It is well understood that electronic media devices may receive text, pictures, and sound from other sources via radio waves, Bluetooth technology, or other transmission mediums. These text, pictures, and sounds may be sent to media devices as part of a promotional activity. Another technology commonly used in the industry is sending electronic coupons and/or encrypted barcodes signifying that the user has purchased some item or performed some task to electronic media devices through radio frequency, Bluetooth, or other transmission mediums. After the barcode is received, the user may redeem the item keyed to that unique barcode at a designated location. However, the circumstances under which customers receive such text, pictures, sound, and barcodes are limited.

One potential avenue to expand the circumstances under which customers receive text, picture, sound, or barcode is utilizing the accelerometer feature common in many mobile electronic devices. The accelerometer measures movement of the device. These measurements may be used as stimuli for applications on the device to perform additional tasks such as communicating with other nearby devices by radio waves, Bluetooth, or other transmission mediums. Systems may be developed to incorporate accelerometer measurements, location determinations, and media device connectivity into promotional systems.

Yet another application relates to geo fencing technology. Users that have signed up for a promotion and enter a venue where that promotion is taking place (e.g., identified by a geo-fence configured by the promotion organizer) may become eligible to receive promotional materials via text, pictures, sound, barcodes, links, etc. Using these background parameters such as geo-fencing, location sensors, accelerometer readings, and information transfer capabilities, electronic media devices may be incorporated into a variety of novel circumstances from large scale promotional activities to treasure hunts.

### BRIEF SUMMARY OF THE INVENTION

The present invention provides a means for a customer to record a user's contact information, location or other such user-specific information during an event using an application for an electronic media device. For example, a sudden jolt registered by the accelerometer of a mobile electronic device, and/or the user's location based on locations sensors (e.g., a GPS receiver) may be used to trigger the sending of information concerning the user. In return, the user may receive any combination of text, pictures, sounds, or encrypted barcode, all of which may be customized by the customer. Additionally, to create more engaging promotions, systems may be configured to use dynamic geo-fencing, so that moving geolocations may be used, or different geolocations may be set to be included in a game for instance, or the size of a virtual geo-fence area may be expanded or contracted depending on activity in game. In a large entertainment venue, geo-fencing may be used in association with a spotlight, or camera to include in a certain promotion fans that are in the spotlight or in the field of view of the camera.

### BRIEF DESCRIPTION OF THE SEVERAL VIEWS OF THE DRAWING(S)

FIG. 1 is a schematic representation of an exemplary system for crowd promotions according to the invention.

FIG. 2 is a map showing a moveable geo-fence.

### DETAILED DESCRIPTION OF THE INVENTION

The invention may best be understood by reference to the exemplary embodiment(s) illustrated in the drawing figure wherein the following reference numbers are used:
2 sudden jolt or impact
4 portable electronic media device
6 backend server
8 accelerometer

The present invention comprises a system for exchanging user contact information for redeemable barcodes, e-coupons, or other material during a promotion using a mobile computing device, herein referred to as a media device. The system provides for a distributed application (mobile app), which may be downloaded as a set of instructions with independent, but connected processing intelligence, and location information, such as GPS coordinates, which may, in part, be used to control when the media device is eligible to receive a transmitted promotion. Examples of portable electronic media devices include mobile smart phones, tablet computers (e.g., the Apple iPad), media players and other such processor-based, portable devices having wireless communications capability, utilize position sensors, and contain accelerometers. As used herein, the term GPS is intended to include all Global Navigation Satellite Systems (GNSS) including, but not limited to, the U.S. Global Positioning System, the Russian Global Navigation Satellite System (GLONASS), the planned European Union Galileo positioning system, India's Indian Regional Navigation Satellite System, and the Chinese Beidou Navigation Satellite System.

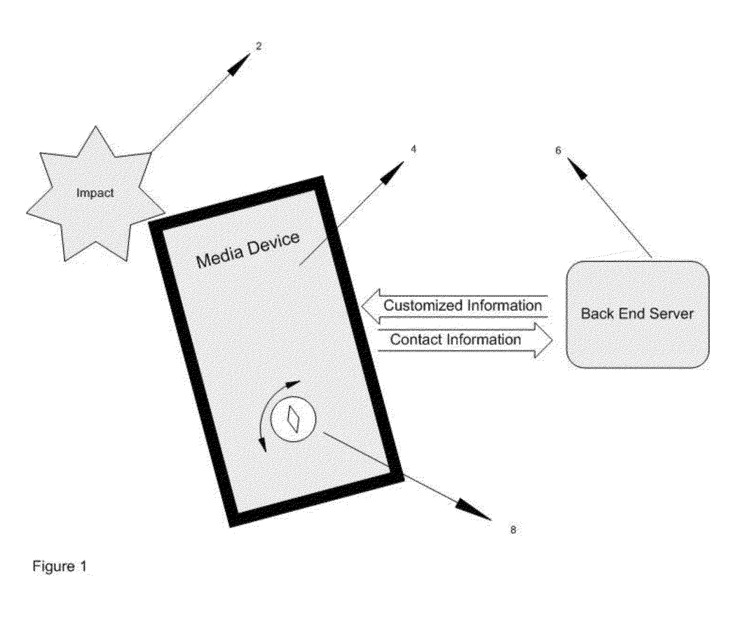

FIG. 1 is a schematic illustration of one system according to an embodiment of the invention. In FIG. 1, any portable electronic media device 4 equipped with an accelerometer 8 and/or location sensors, and the application program that accompanies this system may be used. Any sudden jolt or impact 2 to the portable electronic media device 4 may be registered by the accelerometer 8. A back end server 6 is where the customer may store information related to a particular promotion including but not limited to text, sound, pictures, electronic coupons or barcodes to be sent to a target user of the promotion. Back end server 6 may also be where the potential targeted users register for a campaign using an application on their electronic media device 4 which application may be a free, downloadable application.

In an embodiment, a customer of the promotion system registers through a web-enabled interface to a back end server 6 that they wish to hold a promotion. In a preferred embodiment, that customer will set the location of the event using, for example, a GPS-based mapping program and set a distance from that location where users may take advantage of the promotion. The customer may create a perimeter area, a geo-fence, which may be used to identify users participating in the promotional event. The size and location of the geo-fence may be completely customizable by the customer through the mobile app interface. In one completion, the geo-fence may be drawn very large such as encompassing an entire music festival, concert, or any large scale entertainment event. In another instance, the geo-fence may be drawn very small encompassing only one store or even a certain portion of a store. The customizability of the geo-fence utilized in this invention is only limited by the accuracy of the mobile device's positioning technology. Other techniques include users signaling when they have arrived at the event. The customer may also schedule duration for the promotion by time and date. The scheduling input by the customer may be done through the mobile app. Therefore, the customer may set up time, date, and geo-fence restrictions for a promotion on the back end server 6. For this service, the customer may be charged an hourly rate based on the expected length of the promotion, may potentially be charged by expected number of promotion target users, or may be charged by the size of the geo-fence. Those skilled in the art will recognize a wide variety of payment systems applicable to this invention, all of which are incorporated.

Additionally, the customer may use the app itself to create a promotional event. In one particular preferred embodiment, the customer may create a treasure or scavenger hunt utilizing the location and direction capabilities of many media devices. In this embodiment, many users may log into the mobile app simultaneously to participate in a treasure hunt type event. The customer may send users various pieces of information by text, picture, or sound based upon that user's location and direction in relation to some end location or “treasure.” This process may be completely automated on the back end server 6 based upon customizable parameters set up by the customer. In another embodiment, the customer may set up checkpoints by drawing multiple small geo-fences for a scavenger hunt where users complete each checkpoint by taking a picture there, scanning a barcode, shaking the mobile device at the proper location, simply arriving in the geo-fence area, or any other mobile device activity. In yet another embodiment, the media device screen may change color based upon the location of the user and their distance away from and trajectory towards some set end point. As the user moves closer to the end point, the screen may change from red to green or offer a textual indicator to the user such as “you're getting hot” or “you're getting colder.” Furthermore, the screen may change color based upon the direction the media device 4 is pointing. It is contemplated that this invention may be used in a multitude of ways where stimuli from the user result in an automated response from the back end server 6 through the mobile app where the response and proper stimuli are completely customizable by the customer.

To participate in a promotion, a potential promotion target (user) downloads an application program (app) according to the invention onto media device 4. After downloading, the user may register using the app to enter his or her contact information into an interface provided by the app. Later, in a preferred embodiment, the app automatically arms the device when the user enters the GPS-defined perimeter or geo-fence set by the customer for the duration of the promotion. This app may use the bump API to register media device 4 in response to impact 2 which works using the accelerometer 8 found in most modern media devices. In a preferred embodiment, upon an abrupt jolt 2 of the media device, the app promptly registers that that user may now be eligible for whatever promotion reward there may. In one preferred embodiment, once a user enters the geo-fence the app automatically supplies the customer with a clue to lead them to a subsequent checkpoint as part of a scavenger hunt. In an embodiment, each subsequent checkpoint may be marked by another geo-fence ensuring the customer that the user has actually found all required checkpoints. Further, the app may be programmed to only send the user a subsequent clue for the location of the next checkpoint upon entering the geo-fence drawn around the current checkpoint and performing some task such as taking a picture, shaking the device, or scanning a barcode.

The abrupt jolt 2 registered by the accelerometer 8 that triggers a response from the back end server 6 as part of this invention may be the consequence of the device striking any object or striking an object equipped with technology capable of communicating with the media device 4. In one embodiment, the customer may circulate customizable beach balls common in large entertainment events. A user may strike the beach ball with their media device 4 to generate the jolt. Further, that beach ball may be equipped with technology that communicates with the media device 4 at impact 2 to insure the user has struck the ball e.g., using a near field communication (NFC) link. This communication may also be through Bluetooth, radio signal, or other communication mediums. One skilled in the art may conceptualize many different processes where the user jolts their media device against another object resulting in communication between the two. Therefore, this invention is not limited to the beach ball embodiment. Subsequent to the bump, the user's eligibility may sent to the customer through the back end server 6.

If the user is selected to receive a promotion through use of selection criteria on the back end server 6 (criteria that may be programmed or input by the customer), the back end server 6 may send the user's media device an automatically-generated message containing information. The information may include but is not limited to one or any combination of text, pictures, sounds, e-coupons or barcodes. This information may be entirely customizable by the customer and may include that a certain percentage of users who bump media devices receive different information than others. In one embodiment, only a certain percentage of users who bump media devices receive a barcode which signifies they are eligible to receive a prize. The percentage of prize-winning users or the prizes themselves may be variable and completely at the discretion of the customer.

In yet another preferred embodiment, a user's eligibility for a particular promotion may be established by simply being within the geo-fenced area selected by the customer. In this embodiment, a user's eligibility for a promotion may be determined automatically using the location determination capability of that customer's mobile device 4. No additional action by the user may be required to render them eligible for the promotion.

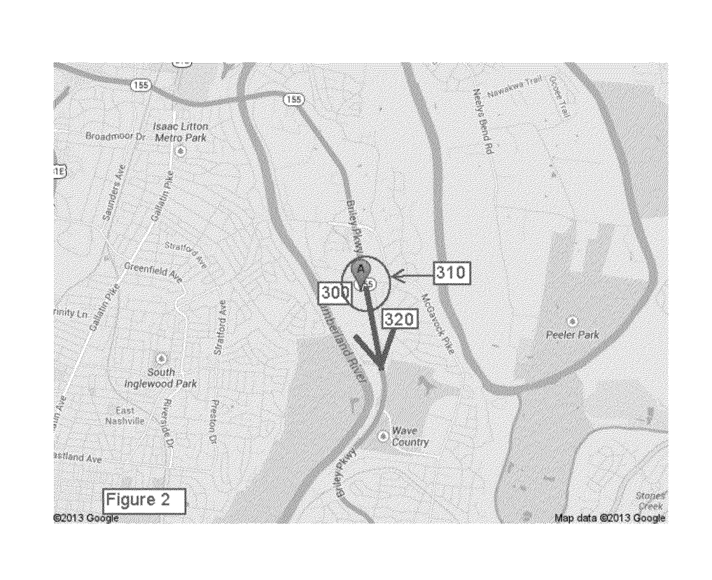

Geo-fencing may be used dynamically to increase the interest of those participating in a game or promotion. The invention adds a motion component to a geo-fence or a vector with an area. The system permits the planner of a promotion to pre-draw the path vectors for the geo-fence. So, the promotion planner may create a geo-fence area on a displayed map, and then create a path or vector on the map over which the center of the geo-fence will traverse. Adding a vector through a user interface is illustrated in FIG. 2. In the illustrated example, a user places a mouse or other pointing device at the location of the Ryman Auditorium 300 (home of the Grand Ole Opry weekly stage concert) on Briley Parkway in Nashville, Tenn., and then draws a vector, 320, directed south along Briley Parkway so that geo-fence area 310 will move south centered on the vector. The purpose of the geo-fence may be to identify mobile devices that are eligible to participate in the game or promotion as a result of being near, in, or out of the geo-fenced area. The system allows the promotion planner to set parameters when the size of the geo-fence would be recalibrated to potentially reduce the number of devices that are participating, changing the direction of the geo-fence dynamically based upon the parameters set by the promotion or game planner.

The parameters of when to move, resize, or otherwise adjust the geo-fence or geo-fences may be preprogrammed in a set game format, or open for selection by a promotion planner. The options on when and how a geo-fence may move, be resized, intersect, and/or encroached upon as competitive control of a specific geographic or virtual space including 2-d, 3-d or planar 3-d space may include, but not limited to, the following:
1. The interaction of the users (devices) in or near the geo-fence.
2. A preset time to designated spots along a preset path along the vector.
3. A count of eligible mobile devices in a particular area.
4. The initiation of an event at a pre-designated location.
5. Interaction between one or more groups of devices within multiple geo-fences based upon game or promoter parameters.
6. Satellite mapping of the movement of an object such as a boat or ship.
7. A 3-d grouping of mobile devices which are targeted by generating display information in real-time and in communication with these devices for visual control, notification, and other multimedia interaction as a pixel in a larger viewing arena.
8. A heat map calibration of devices participating in any game logic in communication with a central or distributed processing network that may comprise a collective of game logic and social interaction and human interface.

A game or promotion may include focusing a geo-fence around one or a cluster of players who for some reason are winning or are exceeding certain criteria. By doing this, current devices that are playing or part of the promotion may be left out or removed from the group. Players or eligible devices may, likewise, be added or substituted. Another example is a game or promotion similar to the game Capture the Flag. The geo-fence may be “won” by holding it by a group of players who either gain positions inside geo-fences or interact in some way, including with the promotions servers, to meet defined criteria. Rewards may be provided for such play. The geo-fences involved in the game may be set across the country or the world, or within a single venue such as a soccer stadium.

Rather than having the geo-fence predefined, in a venue like a concert or ball game, a form of geo-fence may be created on the fly through calibration of the coverage of the outline of a concert spotlight as it moves across crowds as to a projected elliptical area in real time from its 3-d location in a venue. The light may be detected by one or more sensors (e.g., infrared sensors) on the users' devices or other electromagnetic radiation sensors. Such area may be translated into the geo-fence area for purposes of recognizing mobile devices in this area dynamically. The same concept may be useful as well in translating a geo-fence area into the system as converted using the area which may be captured from a camera view for the purpose of polling by geo-fencing mobile devices within this area. Said area as the camera moves may be recalibrated to incorporate the changes in what may captured. In a particular viewing area, the eligible devices may be provided images or other data to display on the screen to create a larger display. Or clothing, accessories, or other devices that are in communication with the mobile device through a communication protocol such as Bluetooth may be illuminated in some specific way.

The displayed designs may be pre-programmed or set on the fly by a director on site. In certain embodiments, the system may be implemented using remotely controlled cameras or by selecting a smaller field of view in a wide angle digital camera.

Under certain gaming parameters, mobile devices may take control of adding vectors to the actual fence and direct its movement under certain conditions. For instance, if certain criteria are met, a player may expand their geo-fence area to incorporate additional team members. Additionally, the back end servers may issue commands to create vectors, either based on preset logic or on-the-fly under the direction of a promotion or game planner. The geo-fences of this system may be three dimensional—i.e., have an altitude component and/or x-, y-, and z-axis limits.

In certain games, actions by players in a particular geo-fenced area may be used. For instance, the number of players in a geo-fenced area that solve a puzzle, or simultaneously take action in some way, may cause a virtual missile or other virtual weapon to be fired at another geo-fenced area. Those players may defend or counter attack using similar actions.

In certain embodiments of the invention, a secure encryption system may be used to incorporate the metes-and-bounds legal title of real property into a separate estate and title system for the ownership and control of a virtual network space.

Ownership interests in real property are commonly defined by geographic boundaries (“metes and bounds”). Cadastral surveys document the boundaries of land ownership by the production of documents, diagrams, sketches, plats, charts, and maps. Cadastral survey information is often a base element in Geographic/Land Information systems used to assess and manage land and infrastructure. The Public Lands Survey System is a cadastral survey of the United States originating in legislation from 1785, after international recognition of the United States. The Dominion Land Survey is a similar cadastral survey conducted in Western Canada begun in 1871 after the creation of the Dominion of Canada in 1867. Both cadastral surveys are made relative to principal meridian and baselines. These cadastral surveys divided the surveyed areas into townships, square land areas of approximately 36 square miles (six miles by six miles; some very early surveys in Ohio created 25 square mile townships when the design of the system was being explored). These townships are divided into sections, each approximately one mile square. Unlike in Europe this cadastral survey largely preceded settlement and as a result greatly influenced settlement patterns. Properties are generally rectangular, boundary lines often run on cardinal bearings, and parcel dimensions are often in fractions, or multiples of, chains. Land descriptions in Western North America are principally based on these land surveys.

Current real estate ownership and the title to real property has as its basis metes and bounds or area. The title of real estate is customarily insured when it is purchased. In certain jurisdictions, there is a separate “mineral” estate that can be sold or leased separately from the surface estate. In oil and gas exploration, it is customary to lease minerals from different owners than those who own the surface of the land. It is also possible to lease or purchase the mineral rights to different strata for certain formations at certain depths. These different “strata” may have different intrinsic market values and hence may be segmented as such for marketing purposes.

Today, the widespread personal possession of mobile computing devices and their near-constant connectivity with data and telecommunications networks, coupled with very accurate GPS and network triangulation location calculators have created a critical problem for owners of real estate. As an example, a retail mall generally is a business where the owner of the “real estate” (landlord) rents space to store owners who sell goods to customers who physically come to shop. These retail businesses count on the landlord of the mall to provide the necessary conditions for shopping. Some of these include the provision of heating and air conditioning, security services, ample parking and a varied selection of stores for shoppers to choose from. The landlord depends upon the shoppers to purchase from the merchants and the merchants to therefore be successful and able to pay their rent. Concerts, tradeshows, and sporting events are additional examples where the real estate and its owner are the basis behind the commerce within the metes and bounds as set forth in title and “owned.”

Another example of the commerce and the ownership of “air” or virtual space was made famous by Donald Trump. He made a successful business through the purchase of the “air space” above buildings for future development in New York City. It was legally determined that owners of land could sell the air rights above these lands for future development to Trump. Hence, title companies recognized this “air space” as an interest in real estate that can be marketed and sold. Although perhaps less tangible than minerals, owning a mineral estate does not guarantee the discovery or production of them in commercial quantities.

The problem is that other companies or individuals can effectively pirate the virtual real estate and related commerce using software which is currently standard, free code provided by publically-available programs to draw geo-referenced “fences” on electronic maps (e.g., “Google Maps”). Using such graphics together with code that is on the processor-based device (e.g., a smartphone or tablet computer), companies in control of the devices are able to create an intrusive connection with their customer while he or she is inside the “envelope” of the real estate owner's property. This intrusion may be disruptive to the business activities and personal “space” of the “owner.” This aspect of the present invention provides a method for “locking the (virtual) doors” of homes, venues, and other commercial real estate.

This aspect of the present invention comprises a secure encryption system to incorporate the Cadastral Descriptions and respective owners of the title of real estate including the ownership and management of virtual space over said areas for wireless processor-based devices which enter said areas as a separate estate or an estate “running with the land” for related personal control and contractual business services.

Fundamental to this optional aspect of the present invention is the fact that the owners of real property have the right to control that real estate and the activities of those who venture inside the metes and bounds of these spaces. The present invention extends this concept to all network-enabled, portable, processor-based, electronic devices.

This aspect of the invention comprises a network and computer-based system that may be in data communication with title companies and/or the public system of real property records across the world that provides the “grant” of an area or fence as recorded metes and bounds of any piece of real estate. This “area” may be associated with an encrypted master software key which is at least initially owned by the title owner of record of the real estate, but can be sold, leased and marketed separately in the system as provided today and filed of record in the proper jurisdictions according to established laws or laws that may be established in the future.

In one embodiment, the title and ownership of this new property right may not be recorded formally as the adoption of this into local laws as it applies to real estate may evolve as will the market of this “virtual asset”. The present invention is in some ways analogous to the domain name (or “internet name”) ownership market. There is one owner and one name associated with each encrypted master key. In this case, the owner of this asset owns an area (or volume) of real estate. This real estate area and respective encrypted keys may be marketed to third parties in the form of a lease or outright sale. There may be one master key per area that may be unlocked by the slave software key dynamically when the device moves into the “virtually” fenced area.

The system may require that all devices have a “key” and that to render a particular device functional inside any “defended or fenced space” the key be installed and functioning to a (standard) specification. Upon entering the defensible space, the device in communication the encrypted “fence space” may automatically unlock the device under one application shell for the purposes of managed commerce while inside the owned virtual area. GPS or other positioning means and network functionality may be disabled for the purposes of custom application software that may be tailored to events and other types of commerce as scheduled through an online network portal system functioning inside the “fenced” space. Devices (or particular applications on a device) without the key application may be selectively disabled.

Some or all applications which are running and utilize the location hardware in communication with the data or telecommunications network may be rendered inoperable as part of the core code in the encryption system as provided within the network.

One aspect of the present invention ties the metes and bounds and respective geographic data to an encrypted key using software and online management through network computing devices.

In another aspect of the invention, the same system may be created and managed in areas that may not have encrypted keys assigned to a specific space and may be designated public spaces and open for (online) rental or purchase. These areas may rented or leased through the online portal and the respective commerce managed by the “online squatter.” All devices inside these public areas may, when entering into these public areas, become the target of the owner of the area via the terms established through an online bidding process and regular payments.

In another aspect of the present invention, the owner of a “virtual venue” may automatically trigger application software and content within the confines of the venue based upon an online event schedule. For instance, the venue owner may bring third party content to the devices inside the geo-referenced fence at defined dates and times dynamically.

In another aspect of the present invention, the structure of the software and network system may serve as a “master shell” with managed key application software to push critical content to devices based upon “where” they are inside the geo-referenced “fenced area.”

In certain embodiments, the “ownership” (and hence control) of a geo-fenced area may be assigned and/or managed by an entity analogous to the Internet Corporation for Assigned Names and Numbers, the nonprofit organization that is responsible for the coordination of maintenance and methodology of several databases of unique identifiers related to the namespaces of the Internet, and ensuring the network's stable and secure operation. Much of ICANN's work has concerned the Internet's global Domain Name System, including policy development for internationalization of the DNS system, introduction of new generic top-level domains (TLDs), and the operation of root name servers. In accordance with the present invention, owners of real property may register with a similar such entity (which may be a government-sanctioned entity) and be assigned a geo-fence coincident with the metes and bounds of the property. From that basic assignment, various permissions and other applications can be applied. By way of example, the owner of a toll road could be assigned a geo-fence running on either side of the right-of-way and block the sending and receiving of text messages within the boundaries of the geo-fence. The speed and movement of the user's device may be part of the texting permission/denial algorithm.

Another example is a system wherein a customer in a first retail establishment is blocked from receiving notice of a discounted price from a nearby second retail store on a certain item in an effort to tempt the customer to leave the first store and move to the second. In this way, the poaching of customers may be prevented by the owner of a geo-fenced commercial establishment and may be part of the integration of fence permissions.

The foregoing presents particular embodiments of a system embodying the principles of the invention. Those skilled in the art will be able to devise alternatives and variations which, even if not explicitly disclosed herein, embody those principles and are thus within the invention's spirit and scope. Although particular embodiments of the present invention have been shown and described, they are not intended to limit what this patent covers. One skilled in the art will understand that various changes and modifications may be made without departing from the scope of the present invention as literally and equivalently covered by the following claims.

What is claimed is:

1. A system for conducting a promotion at an event occurring at a defined location comprising a back end server having instructions stored thereon for causing a processor to:
receive customized promotion information comprising user selection criteria;
receive contact information from at least one user in response to a location determination by a mobile electronic device carried by the user;
receive device information from an application program running on the user's device;
receive triggering information identifying the user's eligibility to participate in a promotion; and,
transmit promotional material to the user's device based on the selection criteria.

2. A system as recited in claim 1 wherein the defined location is a virtual geographic area bounded by a geo-fence.

3. A system as recited in claim 2 wherein the user's eligibility to participate in a promotion depends, at least in part, on a determination that the user's location is within the virtual geographic area bounded by the geo-fence.

4. A system as recited in claim 1 wherein receipt of contact information from at least one user is triggered by an abrupt movement of the user's device.

5. A system as recited in claim 5 wherein receipt of contact information from at least one user is triggered by a substantially concurrent abrupt movement of another device.

6. A system as recited in claim 1 wherein the promotional material transmitted to the user's device is selected from the group consisting of text, images, audio, barcodes and electronic coupons.

7. A system as recited in claim 1 wherein the user's device comprises at least one accelerometer, at least one position sensor and at least one wireless data communications transceiver.

8. A system as recited in claim 2 wherein the size of the virtual geographic area bounded by the geo-fence is dynamically altered by the server.

9. A system as recited in claim 8 wherein the size of the virtual geographic area bounded by the geo-fence is dynamically altered by the server in response to user activity.

10. A system as recited in claim 1 wherein the defined location is defined by the area illuminated by a spotlight.

11. A system as recited in claim 1 wherein the defined location is defined by a selected portion of the field of view of a digital camera.

12. A system as recited in claim 1 wherein the boundaries of the defined location move a preselected distance in a preselected direction during the promotion.

13. A system as recited in claim 1 further comprising instructions for charging the customer based at least in part on the length of the promotion.

14. A system as recited in claim 1 further comprising instructions for charging the customer based at least in part on the number of users from whom contact information is received.

15. A system as recited in claim 1 further comprising instructions for charging the customer based at least in part on the size of the defined location.

16. A system as recited in claim 1 further comprising instructions for causing a certain color to be displayed on a screen display of the user's device.

17. A system as recited in claim 16 wherein the certain color depends, at least in part, on the location of the user's device.

18. A system as recited in claim 16 wherein the certain color depends, at least in part, on the orientation of the user's device.

19. A system as recited in claim 1 wherein the defined location is dependent upon one or more factors selected from the group consisting of: the interaction of the users' devices in or near a geo-fence defining the location; a preset time to designated spots along a preset path along a vector; a count of eligible mobile devices in a particular area; the initiation of an event at a pre-designated location; interaction between one or more groups of devices within multiple geo-fences based upon game or promoter parameters; satellite mapping of the movement of an object; a 3-dimensional grouping of mobile devices which are targeted by generating display information in real-time and in communication with these devices for visual control, notification, and other multimedia interaction as a pixel in a larger viewing arena; and, a heat map calibration of devices participating in a game logic in communication with a central or distributed processing network that comprises a collective of game logic and social interaction and human interface.

20. A method for controlling one or more processor-based devices having means for determining the location of the device and in wireless data communication with a host processor-based device comprising:
assigning a master cryptographic software key to the owner of record of certain real property;
providing the one or more processor-based devices with instructions for causing the processor to determine, based on a concurrent location determination, whether the device is physically located within the metes and bounds of the certain real property; and,
executing certain processor instructions in response to receipt of the software key if a determination is made that the device is within the metes and bounds of the certain real property associated with the software key.
